(19) United States
(12) Patent Application Publication
(10) Pub. No.: US 2006/0218149 A1
(43) Pub. Date: Sep. 28, 2006

(54) Data redaction policies

(75) Inventor: Paul B. Patrick, Manchester, NH (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/341,236

(22) Filed: Jan. 27, 2006

Related U.S. Application Data
(60) Provisional application No. 60/665,667, filed on Mar. 28, 2005.

(51) Int. Cl. G06F 17/30

(52) U.S. Cl. 707/9

(57) ABSTRACT

In accordance with one embodiment of the present invention, there are provided mechanisms and methods for controlling access to data. These mechanisms and methods for controlling access to data make it possible for systems to have improved control over accesses to information by redacting responses made by services accessible by the system based upon a determined current access policy. This ability of a system to redact responses to queries or requests for services in accordance with an access policy makes it possible to attain improved security in computing systems over conventional access control mechanisms that control based upon access privileges to a file, an account, a storage device or a machine upon which the information is stored.

### CLAIM TO PRIORITY

The present application claims the benefit of:

U.S. Patent Application No. 60/665,667, entitled DATA REDACTION POLICIES, by Paul Patrick, filed Mar. 28, 2005(Attorney Docket No. BEAS-01753us4).

### CROSS REFERENCE TO RELATED APPLICATIONS

The following commonly owned, co-pending United States Patents and Patent Applications, including the present application, are related to each other. Each of the other patents/applications are incorporated by reference herein in its entirety:

U.S. Provisional Patent Application No. 60/665,908 entitled “LIQUID DATA SERVICES”. filed on Mar. 28, 2005, Attorney Docket No. BEAS 1753US0;

U.S. Provisional Patent Application No. 60/666,079 entitled “MODELING FOR DATA SERVICES”, filed on Mar. 29, 2005, Attorney Docket No. BEAS 1753US1;

U.S. Provisional Patent Application No. 60/665,768 entitled “USING QUERY PLANS FOR BUILDING AND PERFORMANCE TUNING SERVICES”, filed on Mar. 28, 2005, Attorney Docket No. BEAS 1753US2;

U.S. Provisional Patent Application No. 60/665,696 entitled “SECURITY DATA REDACTION”, filed on Mar. 28, 2005, Attorney Docket No. BEAS 1753US3;

U.S. Provisional Patent Application No. 60/665,667 entitled “DATA REDACTION POLICIES”, filed on Mar. 28, 2005, Attorney Docket No. BEAS 1753US4;

U.S. Provisional Patent Application No. 60/665,944 entitled “SMART SERVICES”, filed on Mar. 29, 2005, Attorney Docket No. BEAS 1753US5;

U.S. Provisional Patent Application No. 60/665,943 entitled “AD HOC QUERIES FOR SERVICES”, filed on Mar. 29, 2005, Attorney Docket No. BEAS 1753US6; and

U.S. Provisional Patent Application No. 60/665,964 entitled “SQL INTERFACE FOR SERVICES”, filed on Mar. 29, 2005, Attorney Docket No. BEAS 1753US7.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to controlling access to data, and more particularly to a mechanism for changing data redaction policies.

### BACKGROUND

Increasingly, enterprises are looking for ways to simplify access and organization of Information Technology (IT) services. One mechanism for providing such IT simplification is Service Oriented Architecture (SOA). Application of SOA principles promises faster development cycles, increased reusability and better change tolerance for software components.

Unfortunately, enterprises that implement SOA often find that the start-up complexities of SOA delays, if not derails, the expected return on investment. While SOA simplifies the complexity of an IT environment, organizations lack sufficient experience with SOA technology required for a quick, trouble-free implementation. Compounding this experience gap, graphical tools for implementing SOA are not readily available, so that data services for use in SOA environments often must be hand-coded. For enterprise-class portal and Web applications, for example, a majority of application development time can be spent on managing data access. A number of factors make data programming difficult and time-consuming, including data access control. Accordingly, there exists a continued need for improved mechanisms for changing data redaction policies in implementing SOA type initiatives.

One problem that arises is controlling access to data by different individuals. One conventional approach includes controlling individual's access to data storage constructs, i.e., files, databases and so forth, using a scheme of access permissions. For example, a user may be granted some combination of read, write, modify and delete authority for a particular file, database or other data storage construct. Such conventional approaches, however, require the user to be cleared for the entire content of the data storage construct.

Another conventional approach includes controlling access to the services by individuals. A problem with such approaches, however, arises from the coarseness of the approaches' granularity—an individual is either permitted to use the service or denied access to the service. Some implementations have sought to ameliorate this drawback by establishing classes of access, i.e., user, administrator and so forth, each class having access to a specific set of functions in the service. Each of these conventional approaches, however, suffers the same limitation—an individual granted access to the service, or the data storage construct, has access to the entirety of the data all of the time. Security alert levels, market activity levels and other external environmental factors act continuously, however, making the security needs constantly changing.

### BRIEF DESCRIPTION OF THE DRAWINGS

FIGS. 1A-1B are functional block diagrams illustrating an example computing environment in which techniques for data redaction may be implemented in one embodiment.

FIG. 2A is an operational flow diagram illustrating a high level overview of a technique for controlling access to data of one embodiment of the present invention.

FIG. 2B is an operational flow diagram illustrating a high level overview of a technique for receiving data under a controlled environment of one embodiment of the present invention.

FIGS. 3A-3B are operational flow diagrams illustrating a high level overview of examples of data redaction techniques in various embodiments of the present invention.

FIGS. 4A-4B are diagrams illustrating a high level overview of example service output data corresponding to the examples illustrated in FIGS. 3A-3B.

FIG. 5 is a hardware block diagram of an example computer system, which may be used to embody one or more components of an embodiment of the present invention.

### DETAILED DESCRIPTION

In accordance with embodiments of the present invention, there are provided mechanisms and methods for controlling access to data. These mechanisms and methods for controlling access to data make it possible for systems to have improved control over accesses to information by redacting responses made by services accessible by the system based upon a determined current access policy prior to returning the response to a requestor. Requestors may be users, proxies or automated entities. Access policies may change because of changes made to the policy by an IT administrator, for example, or change in state due to a change in external factors, such as a changed security level or the like. In an example embodiment, redaction is based upon access policies associated with a security level, which may be a hierarchical arrangement of security classifications or categories. This ability of a system to redact responses to queries or requests for services in accordance with an access policy makes it possible to attain improved security in computing systems over conventional access control mechanisms that control based upon access privileges to a file, an account, a storage device or a machine upon which the information is stored. In other example embodiments, access to information may be controlled in accordance with access policies based upon any quantity, indication or other detectable state with which dissemination of information can be coordinated, including without limitation, market activity, severity of weather, seriousness of infractions on a criminal record, member status in a shopping club and the like.

In one embodiment, the invention provides a method for controlling access to data. One embodiment of the method includes accessing at least one service on behalf of a requester. A result set is received from the at least one service. A determination that an access policy has been changed is received. A subset of the result set, which the requestor is permitted to access, is determined based at least in part on the now current access policy. The requestor can be provided only that portion of the result set that the requestor is permitted to access under the now current access policy. In one embodiment, the information provided to the requestor is the result set received from the service(s) redacted in accordance with the now current access policy if the now current access policy permits the requester to access only a portion of the result set. In one embodiment, determining that an access policy has been changed to a now current access policy can include one or more of determining that an external security level has changed, i.e., a change in condition of the external world has been detected; and determining that a change has been made to an access policy.

While the present invention is described herein with reference to example embodiments for controlling access to data based upon an access policy, the present invention is not so limited, and in fact, the access control techniques provided by embodiments of the present invention are broadly applicable to a wide variety of situations in which control over information dissemination is desirable. By way of example, and not intended to be limiting, in various applications embodiments can provide: more detailed criminal record information for suspected felons than for individuals with less serious infractions in their criminal record; less detailed information about each trade when market trading volume increases; more detailed weather information when the weather is hazardous to travel; more special product offerings to members having premium status with shopping clubs than regular members; less personal information about juvenile offenders than adults; and so forth.

As used herein, the term service is intended to be broadly construed to include any application, program or process resident on one or more computing devices capable of providing services to a requestor or other recipient, including without limitation network based applications, web based server resident applications, web portals, search engines, photographic, audio or video information storage applications, e-Commerce applications, backup or other storage applications, sales/revenue planning, marketing, forecasting, accounting, inventory management applications and other business applications and other contemplated computer implemented services. The term result set is intended to be broadly construed to include any result provided by one or more services. Result sets may include multiple entries into a single document, file, communication or other data construct. As used herein, the term view is intended to be broadly construed to include any mechanism that provides a presentation of data and/or services in a format suited for a particular application, service, client or process. The presentation may be virtualized, filtered, molded, or shaped. For example, data returned by services to a particular application (or other service acting as a requestor or client) can be mapped to a view associated with that application (or service). Embodiments can provide multiple views of available services to enable organizations to compartmentalize or streamline access to services, increasing the security of the organization's IT infrastructure.

Access policies (or “authorization policies”, “security policies” or “policies”) dynamically identify resources (e.g., J2EE resources, an XML document, a section of an XML document, services, information returned by services, etc.) for which access is controlled, entities allowed to access each resource, and constraints that apply to each requestor or group of requesters that attempt to access the resource. A policy can be based on role(s) such that it determines which role(s) are permitted to access a resource under certain conditions. (In various embodiments, roles can be defined to dynamically associate users and/or groups of users based on some criteria. For example, a system administrator role might include all users having a certain skill level and only during certain times of day (e.g., after 5:00 pm)).

In one embodiment, a policy can be specified as follows (wherein items in square brackets indicate alternatives; italic font indicates optional items):

[GRANT, DENY] (action, resource, subject) IF (constraint condition)l . . . IF (constraint condition)N;

Where:

GRANT permits a specified action. DENY revokes it;

Action is the name of a resource or resource attribute to grant or deny access to;

Resource is the name of the resource that this policy will be associated with;

Subject is the name of one or more users, groups and/or roles that are granted/denied the action. A special subject called any denotes that any user, group and role is potentially a subject; and

IF (constraint condition) is one or more optional conditions placed on the action. Conditions can include one or more arithmetic and logical functions and expressions involving attributes of resources or other entities in the system, such as requestor attributes, group membership, dynamic attributes (e.g., time, date, location), and other suitable information.

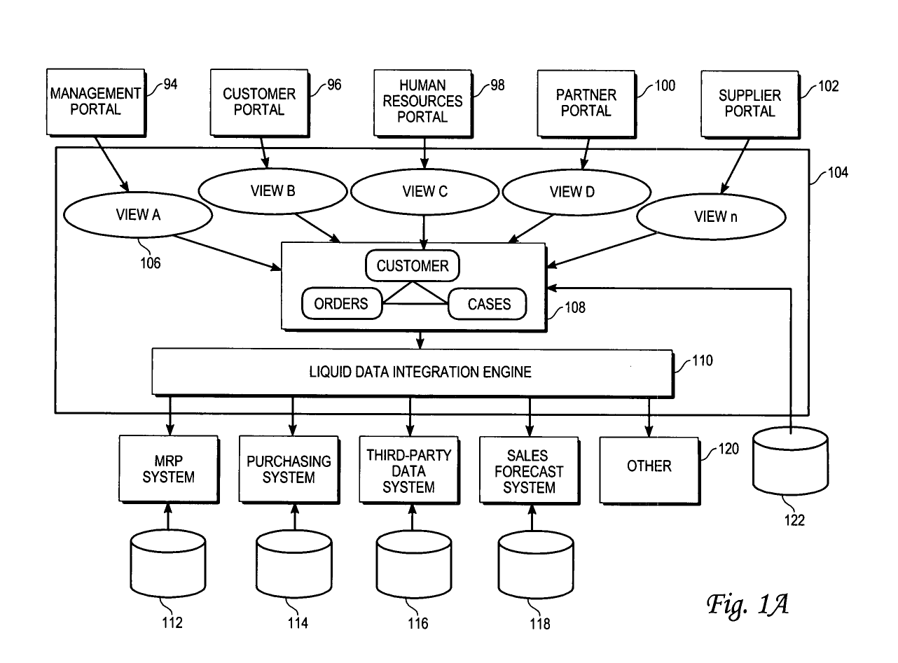

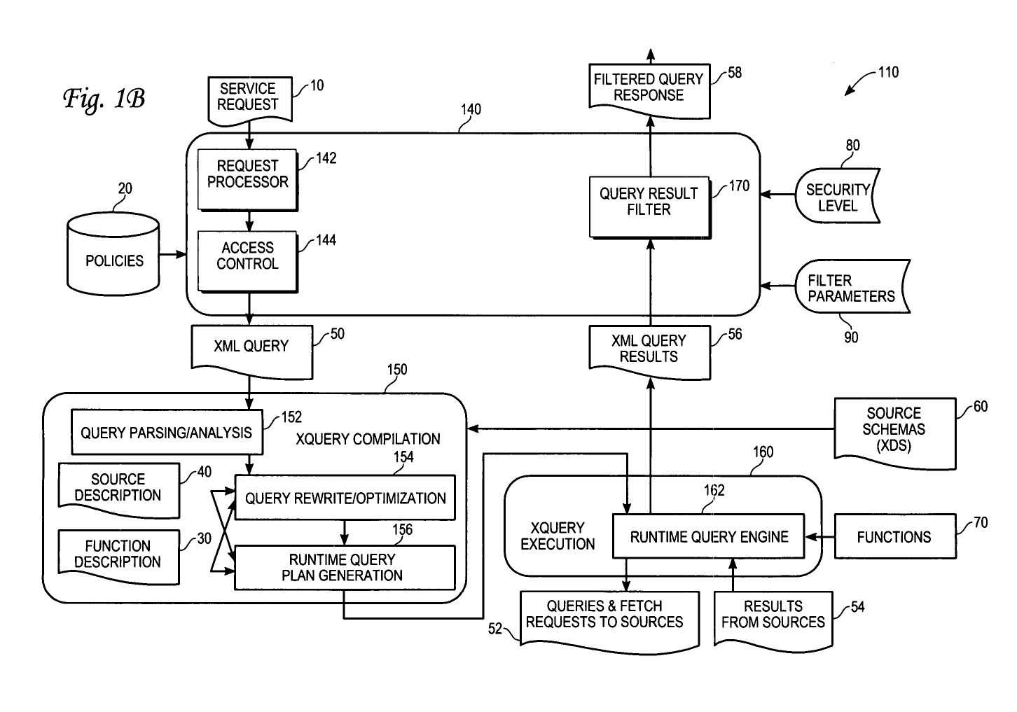

FIGS. 1A-1B are functional block diagrams illustrating an example computing environment in which techniques for data redaction may be implemented in one embodiment. As shown in FIG. 1A, a liquid data framework 104 is used to provide a mechanism by which a set of applications, or application portals 94, 96, 98, 100 and 102, can integrate with, or otherwise access in a tightly couple manner, a plurality of services. Such services may include a Materials Requirements and Planning (MRP) system 112, a purchasing system 114, a third-party relational database system 116, a sales forecast system 118 and a variety of other data-related services 120. Although not shown in FIG. 1A for clarity, in one embodiment, one or more of the services may interact with one or more other services through the liquid data framework 104 as well.

Internally, the liquid data framework 104 employs a liquid data integration engine 110 to process requests from the set of portals to the services. The liquid data integration engine 110 allows access to a wide variety of services, including data storage services, server-based or peer-based applications, Web services and other services capable of being delivered by one or more computational devices are contemplated in various embodiments. A services model 108 provides a structured view of the available services to the application portals 94, 96, 98, 100 and 102. In one embodiment, the services model 108 provides a plurality of views 106 that may be filtered, molded, or shaped views of data and/or services into a format specifically suited for each portal application 94, 96, 98, 100 and 102. In one embodiment, data returned by services to a particular application (or other service acting as a requestor or client) is mapped to the view 106 associated with that application (or service) by liquid data framework 104. Embodiments providing multiple views of available services can enable organizations to compartmentalize or streamline access to services, thereby increasing the security of the organization's IT infrastructure. In one embodiment, services model 108 may be stored in a repository 122 of service models. Embodiments providing multiple services models can enable organizations to increase the flexibility in changing or adapting the organization's IT infrastructure by lessening dependence on service implementations.

FIG. 1B is a high level schematic of a liquid data integration engine 110 illustrated in FIG. 1A with reference to one example embodiment. As shown in FIG. 1B, the liquid data integration engine 110 includes an interface processing layer 140, a query compilation layer 150 and a query execution layer 160. The interface layer 140 includes a request processor 142, which takes the request 10 and processes this request into an XML query 50. Interface layer 140 also includes access control mechanism 144, which determines based upon a plurality of policies 20 whether the client, portal application, service or other process making the request 10 is authorized to access the resources and services required to satisfy the request. Provided that the client, application service or other process is authorized to make the request 10, the interface layer sends the XML query 50 to the query compilation layer 150.

Within the query compilation layer 150, a query parsing and analysis mechanism 152 receives the query 50 from the client applications, parses the query and sends the results of the parsing to a query rewrite optimizer 154. The query rewrite optimizer 154 determines whether the query can be rewritten in order to improve performance of servicing the query based upon one or more of execution time, resource use, efficiency or other performance criteria. The query rewrite optimizer 154 may rewrite or reformat the query based upon input from one or more of a source description 40 and a function description 30 if it is determined that performance may be enhanced by doing so. A runtime query plan generator 156 generates a query plan for the query provided by the query rewrite optimizer 154 based upon input from one or more of the source description 40 and the function description 30.

The query compilation layer 150 passes the query plan output from the runtime query plan generator 156 to a runtime query engine 162 in the query execution layer 160. The runtime query engine 162 is coupled with one or more functions 70 that may be used in conjunction with formulating queries and fetch requests to sources 52, which are passed on to the appropriate service(s). The service responds to the queries and fetch requests 52 with results from sources 54. The runtime query engine 162 of the query execution layer 160 translates the results into a format usable by the client or portal application, such as without limitation XML, in order to form the XML query results 56.

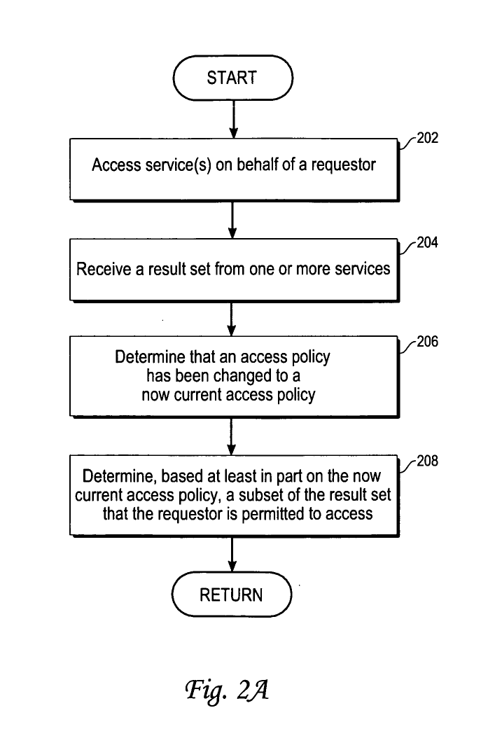

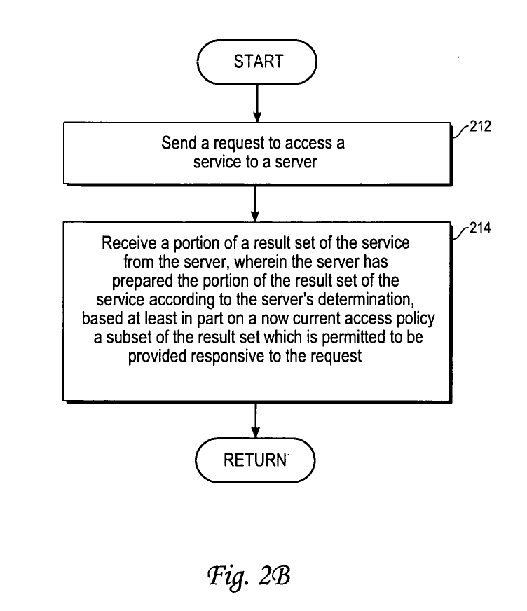

Before responses or results 56 are passed back to the client or portal application making the request, a query result filter 146 in the interface layer 140 determines based upon filter parameters 90 what portion of the results will be passed back to the client or portal application, forming a filtered query response 58. Although not shown in FIG. 1B for clarity, filter parameters 90 may accompany service request 10 in one embodiment. Further, query result filter 146 also determines based upon access policies implementing security levels 80 what portions of the filtered query response 58 a requestor is permitted to access and may redact the filtered query response accordingly. Although not shown in FIG. 1B for clarity, access policies implementing security levels 80 may be stored with policies 20 in one embodiment. Techniques for providing a requestor with only that portion of the information that the requestor is permitted access based upon a access policy implemented by query result filter 170 will be described below in greater detail with reference to FIGS. 2A-2B. When properly formed, the response is returned to the calling client or portal application.

FIG. 2A is an operational flow diagram illustrating a high level overview of a technique for controlling access to data of one embodiment of the present invention. The technique for controlling access to data shown in FIG. 2A is operable with an application sending data, such as Materials Requirements and Planning (MRP) system 112, an purchasing system 114, a third-party relational database system 116, sales forecast system 118, or a variety of other data-related services 120 of FIG. 1A, for example. As shown in FIG. 2A, at least one service is accessed on behalf of a requestor (block 202). A result set is received from the at least one service (block 204). A determination that an access policy has been changed is received (block 206). A subset of the result set, which the requestor is permitted to access, is determined (block 208) based at least in part on the now current access policy. In one embodiment, determining that an access policy has been changed to a now current access policy can include one or more of determining that an external security level 80 as changed; and determining that a change has been made to an access policy 20. The method illustrated by blocks 202-208 may be advantageously disposed in the interface processing layer 140, query compilation layer 150 and query execution layer 160 of FIG. 1B.

FIG. 2B is an operational flow diagram illustrating a high level overview of a technique for receiving data under a controlled environment of one embodiment of the present invention. The technique for receiving data under a secured environment shown in FIG. 2B is operable with an application sending data, such as applications application 94, 96, 98, 100 and 102 of FIG. 1A, for example or a service, such as Materials Requirements and Planning (MRP) system 112, an purchasing system 114, a third-party relational database system 116, sales forecast system 118, or a variety of other data-related services 120 of FIG. 1A. As shown in FIG. 2B, a request to access a service is sent to a server (block 212). A portion of a result set of the service is received (block 214) from the server. The server has prepared the portion of the result set of the service according to the server's determination, based at least in part on a now current access policy, a subset of the result set which is permitted to be provided responsive to the request.

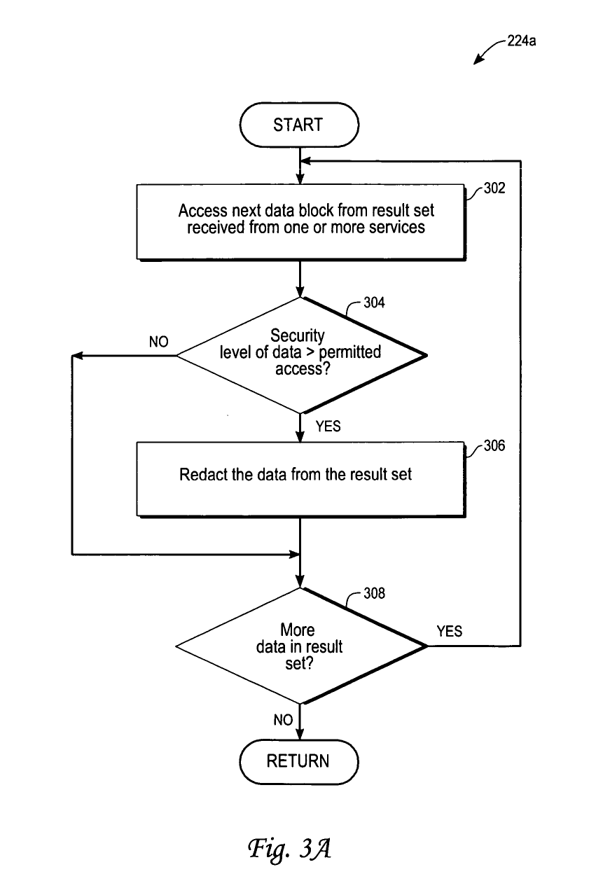

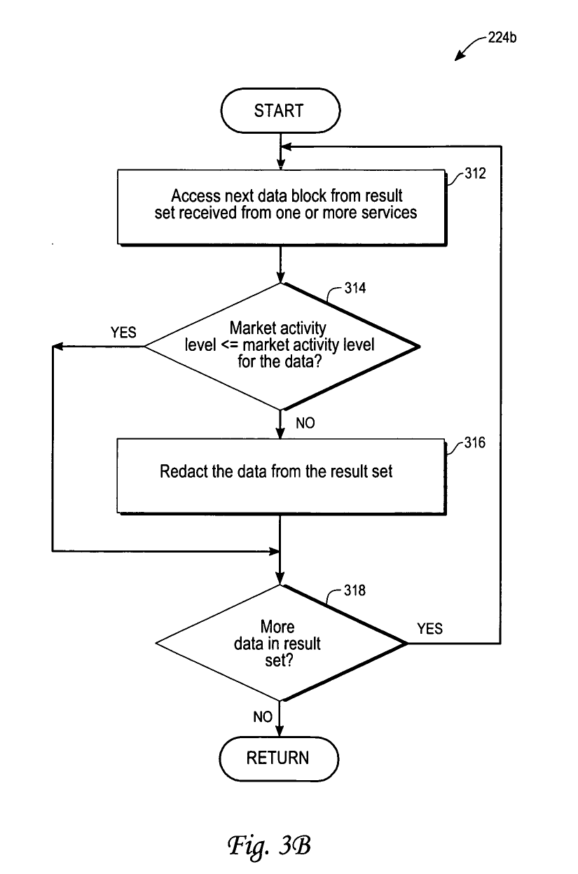

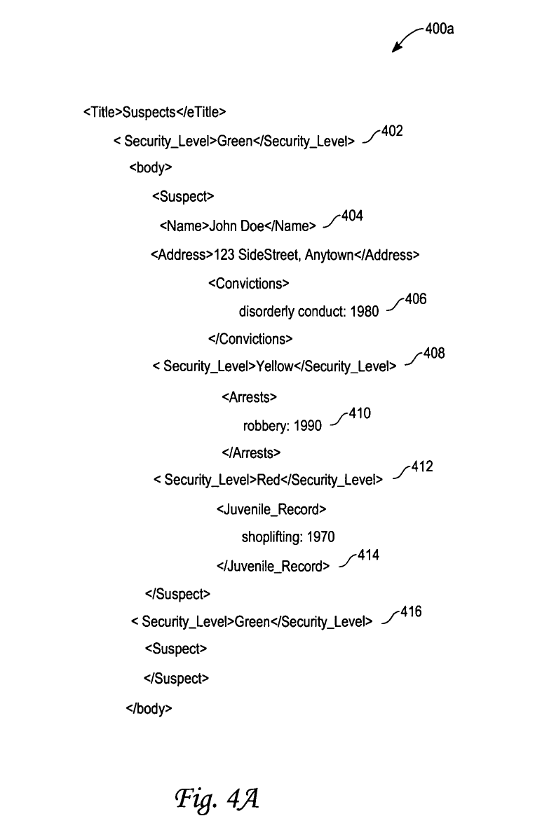

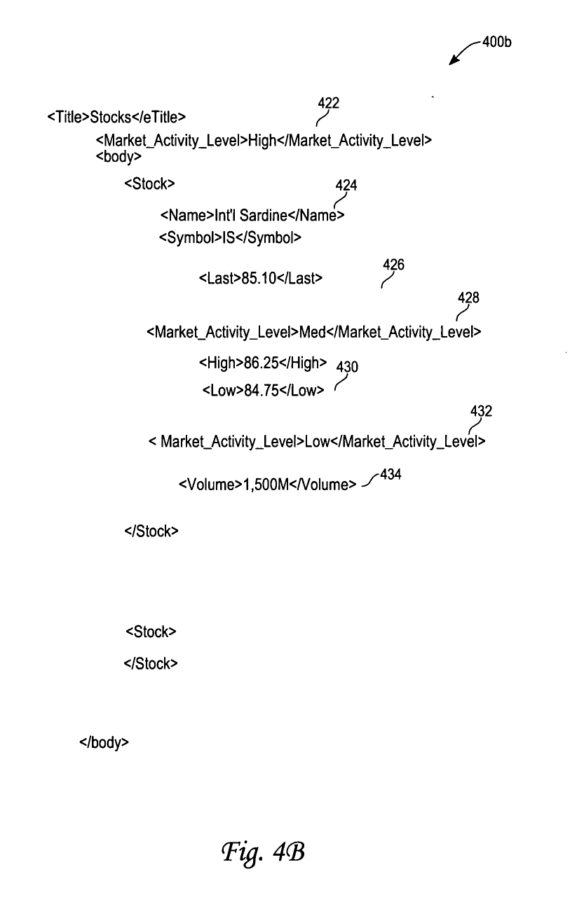

Some of the features and benefits of the present invention will be illustrated with reference to FIGS. 3A-3B, which are operational flow diagrams illustrating some example embodiments implementing example applications. FIGS. 4A-4B are diagrams illustrating example service output data corresponding to the examples illustrated in FIGS. 3A-3B. The reader will appreciate that these examples are for illustrative purposes only and not intended to be limiting.

In a first example, an embodiment employing processing illustrated by FIG. 3A controls access to information based upon a policy by comparing a security level associated with the information and a requestor's permitted access. When used in conjunction with example service output information illustrated by FIG. 4A, which is the input to the processing of FIG. 3A, the embodiment illustrated by FIG. 3A enables access to more sensitive information about suspected violators to be restricted to requestors granted greater authority by access policies. As shown in FIG. 3A, data is accessed from the result set received from one or more services (block 302). If the security level associated with the data is greater than the requestor's permitted access (block 304), then the data is redacted (block 306) from the result set. Otherwise, the data remains in the result set. If more data is to be processed (block 308), more data is accessed (block 302).

In the example service output data illustrated by FIG. 4A, the result set 400a output by a service includes an indication of security level 402. The security level indication 402 indicates that the information following the indicator is accessible to a requestor having access under a policy that includes at least “green” level information. As shown in FIG. 4A, result set 400a includes data for various suspects, including data corresponding to a first suspect, “John Doe.” The data for the first suspect includes information about the suspect beginning with a name and address 404. Since the security level was set to “green” by security level indication 402, the suspect name and address 404 are accessible to requesters permitted by an access policy to access at least “green” level information. A conviction record 406 is also available to requesters permitted access to at least “green” level by an access policy.

A second security level indication 408 indicates that subsequent information requires an access policy permitting access to at least “yellow”. Thus, the arrests data 410 requires requestors to be permitted by access policies to access at least “yellow” level information in order to view this information. A third security level indication 412 indicates that subsequent information requires an access policy permitting access to at least “red”, requiring even further permission to access the juvenile record data block 414. A fourth security level indication 416 returns the security level back to “green”. Thus, information that is restricted by court order and information that is highly prejudicial to a suspect may be included in the same document 400a with information suitable for general access. In this manner, access policies permitting greater access permissions may be required in order to view more sensitive information even though the information is included in the same document 400a in the illustrated embodiment. While colors are used as indicators to demonstrate the functioning of this embodiment, the present invention is not limited to using colors as security level indicators.

Turning again to FIG. 3A, the security level associated with each data 404, 406, 410 and 414 is compared to the requestor's permitted access policy security level (block 304), and redacted (block 306) from the result set if the requestor does not have sufficient access for that particular data. Accordingly, in the foregoing example, as the requestor's access level increases, the amount of information available to the requester also increases. In the next example, a reduction in the amount of information available to the requestor as market activity increases is effected using policies keyed to market activity.

In a second example, an embodiment employing processing illustrated by FIG. 3B controls access to information based upon a policy by comparing a market activity level associated with the information and a present market activity. When used in conjunction with example service output information illustrated by FIG. 4B, which is the input to the processing of FIG. 3B, the embodiment illustrated by FIG. 3B enables access to less information about a stock to as the trading activity level of the market increases. As shown in FIG. 3B, data is accessed from the result set received from one or more services (block 312). If the present market activity level is less than or equal to the market activity level associated with the data (block 314), then no further action is taken and the data remains in the result set. Otherwise, the data is redacted (block 316) from the result set. If more data is to be processed (block 318), then more data is accessed (block 312).

In the example output data illustrated by FIG. 4B, the result set 400b includes an indication of market activity level 422. The market activity level 422 indicates that the information is accessible to any requestor even when the market activity is “high”. As shown in FIG. 4B, result set 400b includes data for various stocks, such as data corresponding to a first stock. The data for the first stock includes information about the stock beginning with a name and “ticker” symbol 424. Since the market activity level is set to “high” by market activity level indication 422, the name and symbol 424 are accessible to users even when the market activity level is high. A last trade price 426 is also available to users at any time. A second market activity level indication 428 indicates that subsequent information requires a market activity of at least “med” to be redacted. Thus, the high and low price data block 430 will be shown if the market activity level is less than “med”. A third market activity level indication 432 indicates that subsequent information about trading volume is included (i.e., not redacted) if market activity is less than “low”, requiring an even slower trading day for the contents of volume data block 434 to be displayed. In this manner, successively greater amounts of information may be omitted when trading volume increases even though the information is included in the same document 400b in the illustrated embodiment.

Turning again to FIG. 3B, the market activity level associated with each data 424, 426, 430 and 434 is compared to the present market activity level (block 314), and redacted (block 316) from the result set if the market activity level equals or exceeds the indicated maximum market activity level for that data. Accordingly, in the foregoing example, as the market's activity level increases, the amount of information available to the requestor decreases.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for controlling access to data as discussed herein.

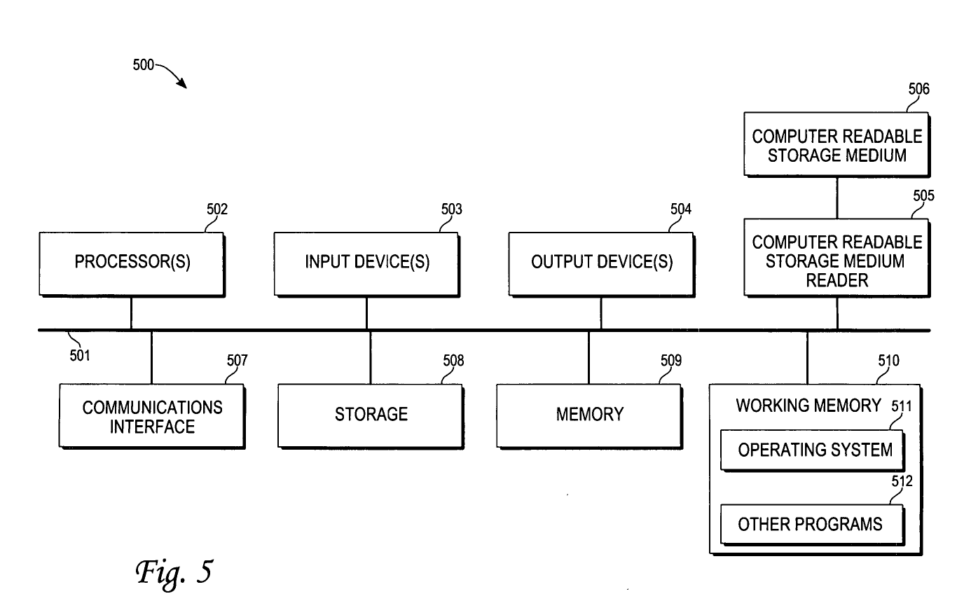

FIG. 5 illustrates an exemplary processing system 500, which can comprise one or more of the elements of FIGS. 1A and 1B. Turning now to FIG. 5, an exemplary computing system is illustrated that may comprise one or more of the components of FIGS. 1A and 1B. While other alternatives might be utilized, it will be presumed for clarity sake that components of the systems of FIGS. 1A and 1B are implemented in hardware, software or some combination by one or more computing systems consistent therewith, unless otherwise indicated.

Computing system 500 comprises components coupled via one or more communication channels (e.g., bus 501) including one or more general or special purpose processors 502, such as a Pentium®, Centrino®, Power PC®, digital signal processor (“DSP”), and so on. System 500 components also include one or more input devices 503 (such as a mouse, keyboard, microphone, pen, and so on), and one or more output devices 504, such as a suitable display, speakers, actuators, and so on, in accordance with a particular application. (It will be appreciated that input or output devices can also similarly include more specialized devices or hardware/software device enhancements suitable for use by the mentally or physically challenged.)

System 500 also includes a computer readable storage media reader 505 coupled to a computer readable storage medium 506, such as a storage/memory device or hard or removable storage/memory media; such devices or media are further indicated separately as storage 508 and memory 509, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 507 may also be included, such as a modem, DSL, infrared, RF or other suitable transceiver, and so on for providing inter-device communication directly or via one or more suitable private or public networks or other components that may include but are not limited to those already discussed.

Working memory 510 further includes operating system (“OS”) 511 elements and other programs 512, such as one or more of application programs, mobile code, data, and so on for implementing system 500 components that might be stored or loaded therein during use. The particular OS or OSs may vary in accordance with a particular device, features or other aspects in accordance with a particular application (e.g. Windows, WindowsCE, Mac, Linux, Unix or Palm OS variants, a cell phone OS, a proprietary OS, Symbian, and so on). Various programming languages or other tools can also be utilized, such as those compatible with C variants (e.g., C++, C#), the Java 2 Platform, Enterprise Edition (“J2EE”) or other programming languages in accordance with the requirements of a particular application. Other programs 512 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 508 or memory 509) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for controlling access to data, the method comprising:
accessing at least one service on behalf of a requestor;
receiving a result set from the at least one service;
determining that an access policy has been changed to a now current access policy; and
determining, based at least in part on the now current access policy, a subset of the result set which the requestor is permitted to access.

2. The method of claim 1, further comprising:
providing to the requester only that portion of the result set which the requestor is permitted to access under the now current access policy.

3. The method of claim 2, wherein determining, based at least in part on the now current access policy, a subset of the result set which the requestor is permitted to access further comprises:
redacting the result set received from the service in accordance with the now current access policy if the now current access policy permits the requestor to access only a portion of the result set.

4. The method of claim 2, wherein determining, based at least in part on the now current access policy, a subset of the result set which the requester is permitted to access further comprises:
providing the result set received from the service in accordance with now current access policy if the now current access policy permits the requestor to access all of the result set.

5. The method of claim 1, wherein determining, based at least in part on the now current access policy, a subset of the result set which the requestor is permitted to access further comprises:
determining that the requestor is to be given a larger portion of the result set as a result of an increase in security.

6. The method of claim 1, wherein determining, based at least in part on the now current access policy, a subset of the result set which the requestor is permitted to access further comprises:
determining that the requestor is to be given a smaller portion of the result set as a result of an increase in security.

7. The method of claim 1, wherein determining, based at least in part on the now current access policy, a subset of the result set which the requestor is permitted to access further comprises:
determining that the requestor is to be given a smaller portion of the result set as a result of a reduction in security.

8. The method of claim 1, wherein determining, based at least in part on the now current access policy, a subset of the result set which the requestor is permitted to access further comprises:
determining that the requestor is to be given a larger portion of the result set as a result of a reduction in security.

9. The method of claim 1, further comprising:
receiving, from the requestor, a request to access the service.

10. The method of claim 1, wherein determining that an access policy has been changed to a now current access policy further comprises at least one of:
determining that an external security level as changed; and
determining that a change has been made to an access policy.

11. A computer-readable medium carrying one or more sequences of instructions for controlling access to data, which instructions, when executed by one or more processors, cause the one or more processors to carry out the steps of:
accessing at least one service on behalf of a requester;
receiving a result set from the at least one service;
determining that an access policy has been changed to a now current access policy; and
determining, based at least in part on the now current access policy, a subset of the result set which the requestor is permitted to access.

12. The computer-readable medium as recited in claim 11, further comprising instructions, which when executed by the one or more processors cause the one or more processors to carry out the steps of:
providing to the requestor only that portion of the result set which the requestor is permitted to access under the now current access policy.

13. The computer-readable medium as recited in claim 12, wherein instructions for carrying out the step of determining, based at least in part on the now current access policy, a subset of the result set which the requestor is permitted to access include instructions for carrying out the steps of:
redacting the result set received from the service in accordance with access privileges associated with the now current access policy if the now current access policy permits the requestor to access only a portion of the result set.

14. The computer-readable medium as recited in claim 13, wherein the instructions for carrying out the step of determining, based at least in part on the now current access policy, a subset of the result set which the requestor is permitted to access include instructions for carrying out the steps of:
providing the result set received from the service in accordance with access privileges associated with the now current access policy if the now current access policy permits the requestor to access all of the result set.

15. The computer-readable medium as recited in claim 11, wherein the instructions for carrying out the step of determining, based at least in part on the now current access policy, a subset of the result set which the requestor is permitted to access include instructions for carrying out the steps of:
determining that the requestor is to be given a larger portion of the result set as a result of an increase in security.

16. The computer-readable medium as recited in claim 11, wherein the instructions for carrying out the step of determining, based at least in part on the now current access policy, a subset of the result set which the requestor is permitted to access include instructions for carrying out the steps of:
determining that the requester is to be given a smaller portion of the result set as a result of an increase in security.

17. The computer-readable medium as recited in claim 11, wherein the instructions for carrying out the step of determining, based at least in part on the now current access policy, a subset of the result set which the requestor is permitted to access include instructions for carrying out the steps of:
determining that the requestor is to be given a smaller portion of the result set as a result of a reduction in security.

18. The computer-readable medium as recited in claim 11, wherein the instructions for carrying out the step of determining, based at least in part on the now current access policy, a subset of the result set which the requestor is permitted to access include instructions for carrying out the steps of:
determining that the requestor is to be given a larger portion of the result set as a result of a reduction in security.

19. The computer-readable medium as recited in claim 11, further comprising instructions, which when executed by the one or more processors cause the one or more processors to carry out the steps of:
receiving, from the requester, a request to access the service.

20. The computer-readable medium as recited in claim 19, wherein accessing a service on behalf of a requester further comprises instructions, which when executed by the one or more processors cause the one or more processors to carry out the steps of:
determining that an external security level as changed; and
determining that a change has been made to an access policy.

21. An apparatus for controlling access to data, the apparatus comprising:
a processor; and
one or more stored sequences of instructions which, when executed by the processor, cause the processor to carry out the steps of:
accessing at least one service on behalf of a requester;
receiving a result set from the at least one service;
determining that an access policy has been changed to a now current access policy; and
determining, based at least in part on the now current access policy, a subset of the result set which the requestor is permitted to access.

22. A method for receiving data under a controlled environment, the method comprising:
sending a request to access a service to a server;
receiving a portion of a result set of the service from the server, wherein the server has prepared the portion of the result set of the service according to the server's determination, based at least in part on a now current access policy, a subset of the result set which is permitted to be provided responsive to the request.
